(19) United States
(12) Patent Application Publication
(10) Pub. No.: US 2014/0214328 A1
(43) Pub. Date: Jul. 31, 2014

(54) SALT BODY EXTRACTION

(71) Applicant: WESTERNGECO L.L.C., HOUSTON, TX (US)

(72) Inventors: JARLE HAUKÅS, SOLA (NO); ODA ROALDSDOTTER RAVNDAL, STAVANGER (NO); LARS SØNNELAND, TANANGER (NO)

(73) Assignee: WESTERNGECO L.L.C., HOUSTON, TX (US)

(21) Appl. No.: 13/752,183

(22) Filed: Jan. 28, 2013

(51) Int. Cl. G01V 1/28

(52) U.S. Cl. CPC G01V 1/282
USPC 702/16

(57) ABSTRACT

A method of extracting a salt body from a geological volume is provided. A starting object is located within the geological volume. The starting object defines an initial salt body boundary. Data points are distributed through the geological volume. The data points are associated with values of one or more geological attributes. The method includes the steps of: defining an expression which determines a change in position of the salt body boundary at the data points over an iteration based on the values of the one or more attributes; and applying the expression at the data points for successive iterations to evolve the salt body boundary over the successive iterations until a final form for the evolved salt body is achieved.

### BACKGROUND

This disclosure relates in general to the extraction of a salt body from a geological volume.

The characterization of subsurface strata is important for identifying, accessing and managing reservoirs. The depths and orientations of such strata can be determined, for example, by seismic surveying. This is generally performed by imparting energy to the earth at one or more source locations, for example, by way of controlled explosion, mechanical input etc. Return energy is then measured at surface receiver locations at varying distances and azimuths from the source location. The travel time of energy from source to receiver, via reflections and refractions from interfaces of subsurface strata, indicates the depth and orientation of the strata.

U.S. Pat. No. 7,248,539 discloses a method for automated extraction of surface primitives from seismic data. For example, one embodiment of the method of U.S. Pat. No. 7,248,539 involves defining, typically with sub-sample precision, positions of seismic horizons through an extrema representation of a 3D seismic input volume; deriving coefficients that represent the shape of the seismic waveform in the vicinity of the extrema positions; sorting the extrema positions into groups that have similar waveform shapes by applying classification techniques with the coefficients as input attributes using unsupervised or supervised classification based on an underlying statistical class model; and extracting surface primitives as surface segments that are both spatially continuous along the extrema of the seismic volume and continuous in class index in the classification volume.

Deepwater drilling is becoming more attractive, and major discoveries have been made in deepwater, subsalt environments. When exploring subsalt hydrocarbon plays, a proper model of the salt deposits can be of great importance, both for seismic depth imaging, and to identify salt related drilling hazards.

Salt body extraction from seismic is conventionally a slow and tedious process, mainly based on manual interpretation. The lack of a suitable methodology for salt extraction can be a major bottleneck in depth migration of seismic data. Furthermore, a proper salt model can be important for the illumination of subsalt targets.

### SUMMARY

In general terms, embodiments of the present invention allow salt bodies to be extracted based on the values of geological attributes, such as seismic attributes obtained from seismic surveying.

A first aspect of the present invention provides a method of extracting a salt body from a geological volume, wherein a starting object is located within the geological volume, the starting object defines an initial salt body boundary, data points are distributed through the geological volume, and the data points are associated with values of one or more geological attributes, the method including the steps of: defining an expression which determines a change in position of the salt body boundary at the data points over an iteration based on the values of the one or more attributes; and applying the expression at the data points for successive iterations to evolve the salt body boundary over the successive iterations until a final form for the evolved salt body is achieved. The method can be a computer-based method. For example, the defining and applying steps can be performed using one or more processors.

In an embodiment of the present invention, a user may automatically and reliably extract salt bodies from seismic data or the like. Embodiments of the present invention also provide for testing different salt body hypotheses by changing input attributes, hence gaining a broader knowledge of the area in question.

A second aspect of the present invention provides a method of operating a well including the steps of: performing the method of the first aspect; and using the extracted salt body to manage the operation of the well. For example, steps may be taken to reduce drilling hazards associated with salt.

Further aspects of the present invention provide: a computer program comprising code which, when run on a computer, causes the computer to perform the method of the first aspect; a computer readable medium storing a computer program comprising code which, when run on a computer, causes the computer to perform the method of the first aspect; and a computer system programmed to perform the method of the first aspect. For example, a computer system can be provided for extracting a salt body from a geological volume, wherein a starting object is located within the geological volume, the starting object defines an initial salt body boundary, data points are distributed through the geological volume, and the data points are associated with values of one or more geological attributes, the system including: one or more processors configured to: define an expression which determines a change in position of the salt body boundary at the data points over an iteration based on the values of the one or more attributes; and apply the expression at the data points for successive iterations to evolve the salt body boundary over the successive iterations until a final form for the evolved salt body is achieved. The system thus corresponds to the method of the first aspect. The system may further include: a computer-readable medium or media operatively connected to the processors, the medium or media storing the location of the starting object within the geological volume, and storing the values of the one or more geological attributes at the data points. The system may further include: a display device for displaying the evolved salt body boundary as a geobody. In particular, the geobody can be displayed in 2D, e.g., as a cross section of the geobody rendered, for example on a seismic intersection, as a polygon representing the salt body boundary,

Further optional features of embodiments of the invention will now be set out. These are applicable singly or in any combination with the any aspect of the invention.

The geological attributes can be seismic attributes and/or geometric attributes and/or numerical modelling derived attributes. Seismic attributes, however, are generally included in the geological attributes.

Seismic attributes are derived by performing mathematical operations on and/or filtering of seismic data. The seismic attributes are typically selected from the group consisting of: seismic amplitude (e.g., measured as a scaled inverse of the amplitude), seismic higher order derivative (e.g., gradient of the amplitude), seismic phase, amplitude vs. offset data, chaos (e.g., as measured by the squared tensor Frobenius norm), variance, curvature, dip, dip deviation and fracture enhancement attributes. U.S. Pat. No. 7,248,539 describes some of these attributes in more detail. Seismic attributes are discussed more fully in T. Randen and L. Sønneland, “Atlas of 3D Seismic Attributes”, chapter 2 of MATHEMATICAL METHODS AND MODELLING IN HYDROCARBON EXPLORATION AND PRODUCTION, ed. A. Iske and T. Randen, Springer, Berlin Heidelberg (2005). In embodiments of the present invention, each data point is associated with at least the respective seismic amplitude.

Geometric attributes can be derived from (manually or automatically) interpreted geometric primitives from a model repository. The geometric attributes are typically selected from the group consisting of: horizontal position, vertical position, proximity to faults, proximity to fractures, horizon surface dip, fault surface dip, proximity to oil-water-contacts, proximity to oil-gas-contacts, number of neighbouring extrema patches (which is an example of more general geometric attributes such as chaos and variance exhibited by local extrema patches), extrema patch area, extrema patch inline extent and extrema patch crossline extent. The geometric attributes can be created automatically or manually from e.g., seismic testing results, or other data such as surface elevation maps, satellite photographs, and gravity, magnetic and/or electromagnetic survey results.

The data points may be voxels.

The method may include the steps of: providing the location of a starting object within the geological volume; and providing the values of the one or more geological attributes at the data points. For example, the location of the starting object and the values of one or more geological attributes can be provided in the form of a computer-readable medium or media. The method may include an initial step of using the geological attributes to determine the location and initial salt body boundary of the starting object in the geological volume.

Generally, the starting object can be any potential salt body or part of a salt body.

The values of the attributes at a given point can be used to define the expression at that point. For example, if the attributes at a given point indicate that that point is in a salt body, then the expression may favour expansion of the salt body boundary through that point in a direction normal to the boundary.

If the values of a plurality of geological attributes can be provided at the data points, in the defining step, the values of the attributes may be scaled relative to each other. This scaling can help to make the effects of the attributes more directly comparable in the expression, i.e., so that undue weight is not put on certain attributes at the expense of other attributes.

The applying step may use the level set approach to apply the expression at the data points for the successive iterations.

The salt body boundary may be fixed at a given data point for subsequent iterations if the boundary has remained stationary at that data point for a predetermined number of successive previous iterations. In this way a stopping criterion can be included which helps to reduce a risk of missing plausible salt boundaries. The overall run time of the method can also be reduced, since calculations to apply the expression may not be required for those data points where the salt body boundary is stationary. The predetermined number of successive previous iterations may be at least 20 or 30. Typically, around 40 successive previous iterations may be suitable. The predetermined number may be the same for all the data points or may vary between data points, allowing for stricter stopping criteria in some regions than in others. For example, the predetermined number may be based on the value(s) of one or more of the attributes at each data point.

Additionally or alternatively, the salt body boundary may be fixed at a given data point for subsequent iterations if the value(s) of one or more of the attributes at that data point match a predefined criterion. For example, an attribute can be a flag indicating the locations of predefined salt boundaries, or regions where data is unreliable such that it would be unreasonable to try to extract a salt body, and the predefined criterion can then simply be the presence of the flag. In a more complex example, boundary evolution may be stopped locally at data points where one or more of the attributes reveal an attribute extrema. The method may include the step of displaying the evolved salt body boundary as a geobody. This can facilitate overview by a user of the evolved salt body boundary. In particular, the geobody can be displayed in 2D, e.g., as a cross section of the geobody rendered, for example on a seismic intersection, as a polygon representing the salt body boundary.

The method may further include initial steps of: performing seismic testing (e.g., seismic surveying); and analysing results of the seismic testing to generate the data points distributed through the geological volume, each data point being associated with the values of one or more respective seismic attributes. For example, the analysis step may include any one or more of: extraction of surface primitives and fracture network mapping. The method may further include an initial step of analysing the results of the seismic testing to generate geometric attributes. For example, the shapes and positions of surface horizons, faults and fractures can be extracted from the extrema, and these shapes and positions then allow geometric attributes such as dips, proximities, etc., to be calculated.

Further optional features of some embodiments of the present invention are set out below.

### BRIEF DESCRIPTION OF THE DRAWINGS

Embodiments of the invention will now be described by way of example with reference to the accompanying drawings in which:

FIG. 1 is a schematic illustration of the normal force Fₙ(x) acting on an object (dark ellipse in left hand image) shrinking it when the normal force is negative (−1) and expanding it when the normal force is positive (+1);

FIG. 2 is a schematic illustration of the directional force Fₑ in the form of a uniform vector field acting on an object (dark ellipse in left hand image);

FIG. 3 is a schematic illustration of the directional force Fₑ in the form of forces pointing towards a contour C and acting on an object (dark ellipse in left hand image), the forces reducing with distance from the contour;

FIG. 4 is a schematic illustration of the curvature force F_{c}(x) acting on an object;

FIG. 5 shows the evolution (a)-(f) of a salt body boundary superimposed on a seismic inline/crossline intersection, green boundary points indicating where evolution has stopped and pink boundary points indicating where evolution is still on-going;

FIG. 6 shows seismic seismic data representing (a) one dominant direction, (b) two almost orthogonal dominant directions, (c) structure meeting chaos (no dominant direction), and (d) chaos;

FIG. 7 shows (a) a seismic amplitude cross-section, the red circle identifying a point where a reference amplitude value is picked, and (b) the same cross-section showing the scaled inverse of the amplitude and highlighting the low amplitude characteristics of salt;

FIG. 8 shows the evolution of a salt body boundary superimposed on a seismic inline/crossline intersection, blue colours indicate a positive vertical force component (downwards), red colours indicate a negative vertical force component (upwards), and the green line illustrates the boundary (a) before and (b) after applying a directional force;

FIG. 9 shows (a) blue points representing an explicit user constraint such as an interpreted top salt, and (b) the salt body (pink volume) extracted by specifying a seed point below the user constrained region, and applying a uniform positive normal force together with a local directional force field imposed by the user constraint;

FIG. 10 shows (a) the normal force attribute, blue colours indicating positive normal force, red colours indicating negative normal force, and white representing zero values, the black line being the boundary starting point, (b) the boundary (green line) that results from applying the normal force with a curvature constraint coefficient of 0.5, and (c) the boundary (green line) that results from applying the normal force with no curvature constraints;

FIG. 11 shows two views of an extracted salt body;

FIG. 12 shows (a) regions where a new salt model derived from application of the level set method was found to coincide with an original salt model, and (b) regions where the new salt model suggested an increased salt extent relative to the original salt model; and

FIG. 13 shows a map representing risk of poor subsalt illumination due to uncertainties in the salt definition above, strong red values indicating a high number of additional salt voxels, and therefore representing regions with higher risk of poor subsalt illumination.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements without departing from the scope of the invention.

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

As disclosed herein, the term “computer readable medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The geological volume can be treated as being a collection of horizon surfaces (often referred to as seismic events or strata) that are defined at the positions of seismic data zero-crossings, maximum values or minimum values. Known methods by which such a sparse surface representation of a seismic data volume may be obtained are diverse, including manual interpretation, connected component labelling of extrema cubes and extrema classification.

Extrema detection, in particular, is a well-known concept in signal and image processing, and there are many algorithms and techniques for performing such detection. For example, applying the extrema classification method discussed in U.S. Pat. No. 7,248,539, it is possible to obtain a sub-sample precision representation of all extrema within a seismic volume using volume reflection spectral decompositions (as discussed in WO 98/37437).

A particular advantage of using the approach of U.S. Pat. No 7,248,539 for extracting connected horizon surfaces is that it can provide robust and versatile solutions even when faulted or chaotic regions are encountered.

More generally, extrema classification methods for horizon extraction can provide very good characterization of the local signal shape, as well as shape similarity throughout the area of interest.

Fault identification in seismic data can be performed e.g., by using swarm intelligence through the deployment of artificial ants (“Ant Tracking”) into attribute volumes, as described in U.S. Pat. No, 7,203,342 and in Pedersen, S. I., T. Randen, L. Sønneland, and O. Steen, Automatic Fault Extraction Using Artificial Ants, 72ND SEG ANNUAL MEETING, Salt Lake City (2002).

Analysis, for example through calculation of seismic attributes, and information from well logs (as described in WO 2008/086352), can also reveal 3D sub-volumes containing fracture networks. In particular, fracture enhancement attributes enhance signals caused by fractures in seismic data.

Having identified sub-volumes of interest, fracture extraction can be performed on the fracture enhancement attributes, to obtain a geometrical representation of the fracture networks. Fracture extraction can proceed by identifying discontinuities in the fracture enhancement attribute. One example of a fracture network extraction procedure is again described in U.S. Pat. No. 7,203,342.

In particular, by applying such techniques, it is possible to obtain a geological volume in which data points distributed throughout the volume are associated with respective seismic and geometrical attributes. Typical seismic attributes are seismic amplitudes and phases for the data points. These amplitudes and phases can be, for example, the starting values for the extrema classification method of U.S. Pat. No 7,248,539. Typical geometric attributes are the horizontal and vertical positions of the respective data points, and the proximity to faults and fractures, as identified, for example, by the approach of U.S. Pat. No. 7,203,342.

A starting point for a method in accordance with an embodiment of the present invention may be the location of a starting salt body within a geological volume, the starting body defining an initial salt body boundary. For example, the starting salt body can be one or more “seed” points in regions of the volume which are almost certainly salt, or can be a larger body corresponding to a previous extraction.

In embodiments of the present invention, an expression is defined which determines a change in position of the salt body boundary, and the expression is applied for successive iterations to evolve the salt body boundary over the successive iterations until a final form for the salt body is achieved. There are various possible “deformable models” or “active contour” approaches which can be used in accordance with embodiments of the present invention to extract an object by deforming a curve, and thereby evolve the object boundary. The two main approaches are parametric and geometric active contours (see, e.g., Chenyang Xu, Anthony Yezzi Jr., and Jerry L. Prince, On the Relationship between Parametric and Geometric Active Contours, PROCEEDINGS OF 34TH ASILOMAR CONFERENCE ON SIGNALS, SYSTEMS, AND COMPUTERS, pp. 483-489 (October 2000); and Tim McInerney and Demetri Terzopoulos, Deformable Models in Medical Image Analysis: A Survey, MEDICAL IMAGE ANALYSIS, Vol 1, pp. 91-108 (1996)). In the parametric active contour approach, also called the Snake method, an initial, explicitly defined contour is deformed based on a set of forces applied to it. These forces can be determined from an image on which the object extraction takes place. The geometric active contour approach, also called the level sets approach, is an implicit method, such that there is no explicit moving contour (see Sethian, J. A. Level Set Methods and Fast Marching Methods, CAMBRIDGE UNIVERSITY PRESS 91996)0. A level set function is deformed based on a set of forces applied to it, forces that can be determined from an image on which the object extraction takes place. The resulting contour is obtained by taking the zero level of the function (where the function is equal to zero)—hence the name “level sets.”

In embodiments of the present invention, the level set approach is used, and this approach is now described in more detail. The level set algorithm is based on solving the differential equation given by

φₜ+Fₙ(x)∥∇φ∥+Fₑ(x)·∇φ−F_{c}(x)κ∥∇φ∥=0 (1)

where φ is the level set function.

The level set function is defined in every voxel (data point) of the image, and is an implicit formulation of the movement of an object boundary submitted to forces. The object (i.e., salt body) boundary is given by

Γ(t)={x=(x₁, x₂, x₃)|φ(x, t)=0} (2)

and in embodiments of the present invention, it is assumed that φ>0 inside the object and φ<0 outside the object. As the function φ is updated in each voxel, the object boundary evolves.

The vector x corresponds to the voxel position and in the case of a seismic cube:

x=(xᵢₙₗᵢₙₑ, x_{crossline}, x_{vertical}).

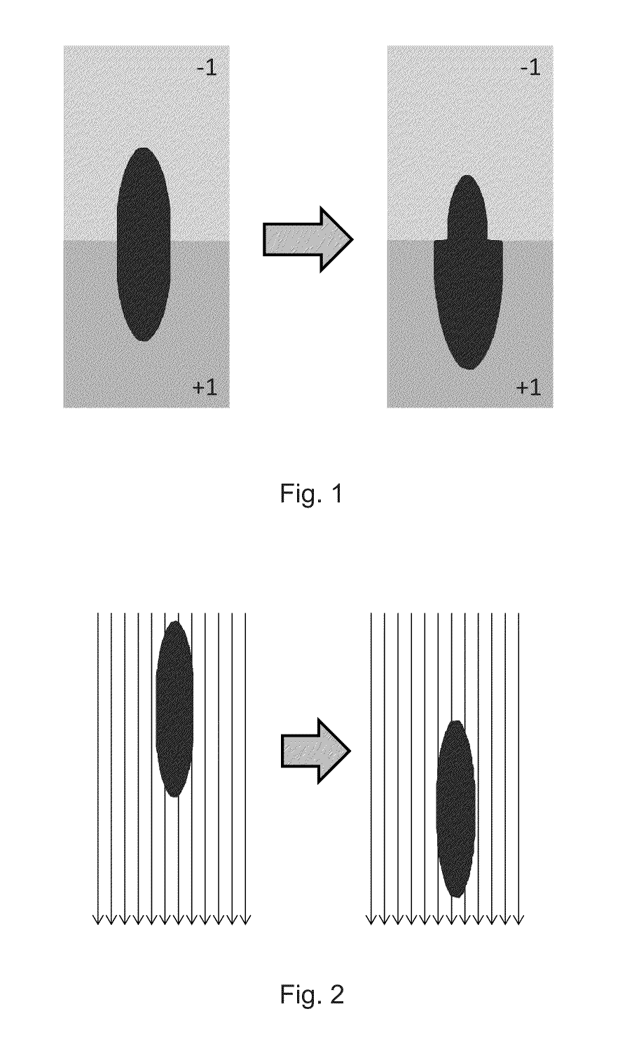

The level set equation given by Eq. (1) can be divided in three distinct terms, excluding the time derivative φₜ. The first term, called normal force, describes the motion in a direction normal to the object boundary as shown in FIG. 1. Fₙ(x) gives the magnitude of this force for each voxel.

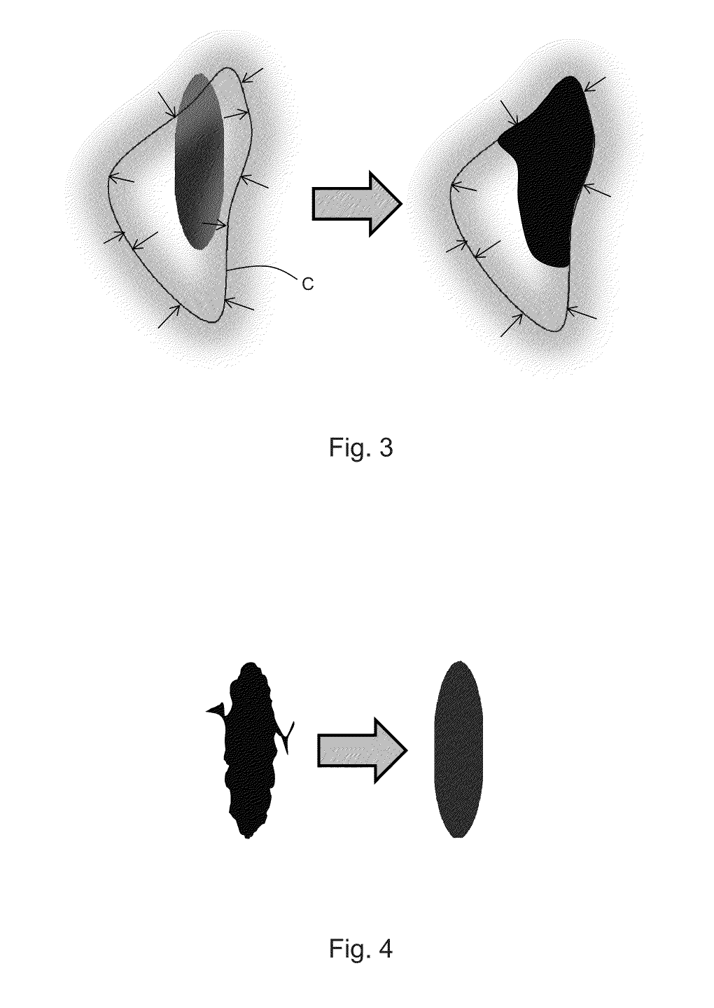

The second term, called directional force, describes the motion in a direction given by the vector Fₑ(x), where Fₑ=(Fᵢₙₗᵢₙₑ,F_{crossline},F_{vertical}) for the case of a seismic cube. Examples can be seen in FIGS. 2 and 3.

The third term, called the curvature force, describes the motion such that the boundary mean curvature κ is minimized and the boundary appears smooth. F_{c}(x) governs the strength of this force. The boundary mean curvature is given by

$$κ = ∇ \cdot \frac{∇ ϕ}{\vert ∇ ϕ \vert} = \frac{{ϕ}_{1}^{2} ( {ϕ}_{22} + {ϕ}_{33} ) + {ϕ}_{2}^{2} ( {ϕ}_{11} + {ϕ}_{33} ) + {ϕ}_{3}^{2} ( {ϕ}_{11} + {ϕ}_{22} )}{{( {ϕ}_{1}^{2} + {ϕ}_{2}^{2} + {ϕ}_{3}^{2} )}^{\frac{3}{2}}} - \frac{2 ( {ϕ}_{12} {ϕ}_{1} {ϕ}_{2} + {ϕ}_{23} {ϕ}_{2} + {ϕ}_{3} + {ϕ}_{13} {ϕ}_{1} {ϕ}_{3} )}{{( {ϕ}_{1}^{2} + {ϕ}_{2}^{2} + {ϕ}_{3}^{2} )}^{\frac{3}{2}}} \qquad ( 3 )$$

where φᵢ, i=(1,2,3) denotes the partial derivative of φ with respect to xᵢ. FIG. 4 shows an example of this force applied to an object.

The level set algorithm can be implemented using an iterative numerical scheme given by

φⁿ⁺¹=φⁿ−Δt(Fₙ∥∇φⁿ∥+Fₑ·∇φⁿ−F_{C}κⁿ∥∇φⁿ∥ (4)

The level set function φ can thus be updated until the force terms reach an equilibrium position, or a specified number of iterations is reached. The initial function φ⁰ at the starting iteration corresponds to an object at a known location within a geological volume and having a defined object boundary. In embodiments of the present invention, upwind direction gradients for both the normal force term (generalized upwind/Engquist-Osher scheme) and the directional force term (ordinary upwind) may be used. In embodiments of the present invention, a mean curvature κ is calculated using central differences.

In embodiments of the present invention, both the spatial and time derivatives can be calculated using finite differences. The order of the finite difference scheme can be selected based on an evaluation of the need of precision versus the computational effort. First order schemes for both spatial and time derivatives can be sufficiently precise and are computationally efficient.

In embodiments of the present invention, in order to ensure the stability of this explicit time scheme, the CFL (Courant-Friedrich-Levy) condition may be used, which states that the boundary of the object can move no more than one voxel per iteration. This translates mathematically to

$$Δ t \leq \frac{α}{{max}_{x ∈ Ω} [ \vert \frac{{F}_{n}}{‖ ∇ ϕ ‖} {\sum }_{i = 1}^{3} \frac{\vert {ϕ}_{i} \vert}{Δ {x}_{i}} \vert + {\sum }_{i = 1}^{3} \frac{\vert {F}_{e , i} \vert}{Δ {x}_{i}} + {\sum }_{i = 1}^{3} \frac{\vert 2 {F}_{c} \vert}{Δ {x}_{i}^{2}} ] } \qquad ( 5 )$$

where Ω represents all possible voxels and α is the CFL factor and thus 0<α<1.

From equation (4), the evolution speed depends on the gradient ∇_{φ} of the level set function. Sometimes, the level set evolution can lead to a smoothing of the level set function values, thus reducing ∇_{φ}. Consequently, evolution of the body can halt even though non-zero net forces are applied. In such cases, a re-initialisation of the level set function e.g., to φ=±1 may be necessary. Re-initialisation is typically performed every m-th iteration, where m around 20 is reasonable.

The level set algorithm can be time-consuming, particularly on large data sets. Thus, in embodiments of the present invention, in order to improve efficiency, a narrow band implementation may be adopted (see Sethian, J. A. Level Set Methods and Fast Marching Methods, CAMBRIDGE UNIVERSITY PRESS (1996)) whereby the calculations take place only in a band around the current boundary. In an embodiment of the present invention, the band is updated every iteration. In addition, to improve the computational complexity and the storage requirements a Dynamic Tubular Grid data structure can be implemented (see Nielsen, M. B., and K. Museth. Dynamic Tubular Grid: An Efficient Data Structure and Algorithms for High Resolution Level sets, JOURNAL OF SCIENTIFIC COMPUTING.” 26, no. 3, 261-299 (2006)).

In an embodiment of the present invention, when the level set evolution stabilizes in a region due to equilibrium of the applied forces, it suggests that a plausible boundary has been identified. However, unless otherwise specified, calculations would go on in this region. Depending on the stability of the force equilibrium, the extracted body could “leak” out of this region, away from the plausible boundary. To address this problem, in embodiments of the present invention, a stopping criterion can be included which specifies that if a voxel has been in the boundary set φ=0 for more than a predetermined number of iteration steps, calculations are no longer performed for that voxel. Consequently, the risk of missing plausible salt boundaries is reduced. At the same time, the overall run time is reduced, since the region where calculations are performed is reduced. In some aspects, a value of around 40 is found to be generally suitable for the predetermined number of iteration steps. However, the predetermined number can vary between data points, allowing for stricter stopping criteria in some regions than in others.

Additionally or alternatively, in some embodiments of the present invention, a stopping criterion can be included which specifies that the salt body boundary is fixed at a given data point for subsequent iterations if the value(s) of one or more of the attributes at that data point match a predefined criterion. For example, an attribute can be a flag indicating the locations of predefined salt boundaries, or regions where data is unreliable such that it would be unreasonable to try to extract a salt body. The predefined criterion can then simply be the presence of the flag. The flag may distinguish between, e.g., predefined salt boundaries and data points where data is unreliable, allowing the stopped boundary to be appropriately labelled as undefined boundary points rather than salt body boundary data points.

However, the predefined criterion may be more complex. For example, boundary evolution may be stopped locally at data points where one of the components of the directional force (which in turn is calculated from the values of the one or more attributes) changes sign. Such changes of sign occur when the directional force field has an equilibrium in that component direction. Thus, if the directional force is based on the gradient of the seismic or the gradient of some other attribute, a shift in sign identifies an extrema along that direction. Consequently, the predefined criterion can be used to stop the boundary evolution at attribute extrema.

In some embodiments of the present invention, a global stopping criterion can also be adopted. Under this criterion, the entire run can be stopped when a predetermined percentage of the total boundary is fixed due any one or more of the above local stopping criteria. The percentage of the boundary that needs to be fixed before stopping the run can be specified by the user. The number of boundary data points and the percentage of those points that are fixed can be monitored during the run. This allows the user to intervene and stop the run if the boundary does not evolve as expected.

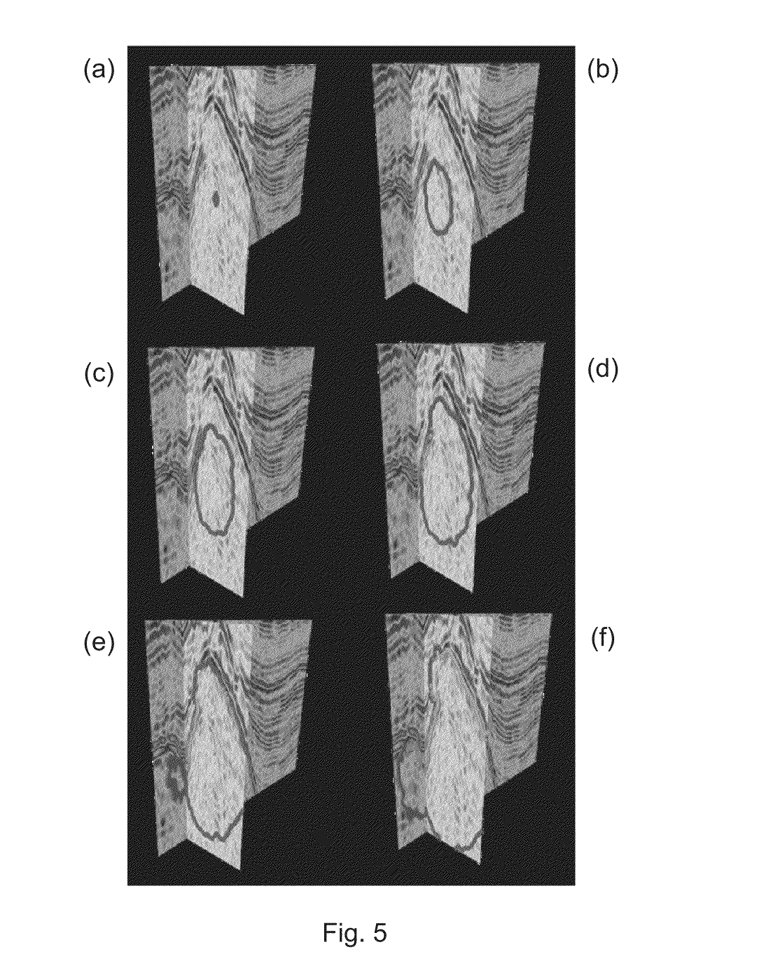

The stopping criteria provide the opportunity to separate between regions where the salt boundary extraction is completed, and regions where the evolution has not yet hit a proper salt boundary. This can be an important input for quality control and editing of the level set result, as it highlights regions where further investigation may be needed. In addition, such a separation makes sense for an iterative depth migration process, where a top salt interface typically must be established before a base salt interface can be identified. In that case, the level set algorithm may be stopped when a top salt interface is completed, even if no proper base salt interface has been identified. After a new migration step that improves the base salt definition, the level set algorithm can be restarted from the previous result. The stopping criterion concept is illustrated in FIG. 5, which shows the evolution (a)-(f) of a salt body boundary superimposed on a seismic inline/crossline intersection, green boundary points indicating where evolution has stopped and pink boundary points indicating where evolution is still on-going.

Next salt body extraction using the level set approach and by specifying forces based on seismic attributes, in accordance with an embodiment of the present invention, is described.

Starting from the initial salt body (i.e., one or more “seed” points or a larger body corresponding to a previous extraction), in an embodiment of the present invention, normal, directional and curvature forces based on seismic attributes are applied. An aim of such aspects is to trace out all relevant salt bodies that can be accessed by evolving from the initial body. By convention, a positive normal force implies growth of the body, while a negative normal force implies shrinkage. Thus positive normal force values grow the body into regions where the attribute response suggests salt, and negative normal force values pull the body back from sediment regions. Furthermore, a directional force field can be used to stop growth at suitable extrema positions, e.g., at a peak for top salt and a trough for base salt. Also, a curvature force field can usefully obtain a smooth transition between salt and sediments in regions where the normal force and directional force attributes are not conclusive. Examples of suitable attribute forces are discussed below.

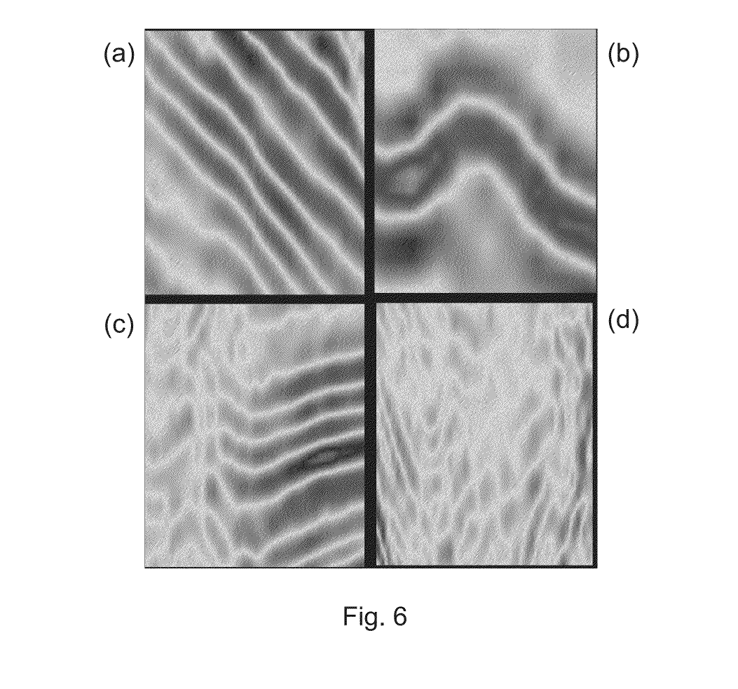

Generally speaking, salt is characterized by lack of seismic structure and low reflectivity (low amplitudes). The differences in structure between salt and sediments mean that we expect the normal vector field of the seismic to behave more chaotically in salt regions than in sediment regions (see A. Iske and T. Randen (editors) (2000), Mathematical Methods and Modelling in Hydrocarbon Exploration and Production, SPRINGER). Using a local analysis of the unit normal vector field, the eigenvalues λ₁, λ₂, λ₃ of the local structure tensor distinguish between regions where the normal field has one dominant direction (λ₁≈1, λ₂≈λ₃≈0) and regions of chaos (λ₁≈λ₂≈λ₃≈⅓). Other limiting cases are regions where two almost orthogonal directions are represented (λ₁≈λ₂≈½, λ₃≈0), e.g., salt diapir tops, and regions where chaos meets structure (λ₁≈⅔, λ₂≈λ₃≈⅙), e.g., terminations. Examples of these cases are illustrated in FIG. 6.

Thus the squared tensor Frobenius norm:

ξ=λ₁²+λ₂²+λ₃² (6)

can be a suitable single attribute for distinguishing between salt and sediments, since ξ≈1 for sediment structure, ξ≈⅓ for chaos and ξ≈½ for terminations and salt diapir tops.

In some embodiments of the present invention, the normal force field is rescaled to the range [−1, 1]. Large positive values imply fast growth, large negative values imply pulling back quickly, while the values around zero represent slowing down the evolution to identify a proper salt boundary. Thus, taking the squared tensor Frobenius norm as an example, the ξ range [⅓, . . . , ½, . . . , 1] can be mapped to [1, . . . , 0, . . . ,−1]. Consequently, ξ=⅓ implies fast normal growth, ξ=1 represents fast shrinkage, while values around ξ=½ imply that normal evolution slows down, approaching terminations of sediments against salt. Values around ξ=½ represent regions of uncertainty for the attribute. From that point of view, having a reduced impact of the normal force (values around 0) in such regions is a suitable strategy. Generally, in regions where the normal force attribute is not conclusive in discriminating between salt and sediments, forces that are less uncertain, e.g., extrema based forces, can be allowed to dominate.

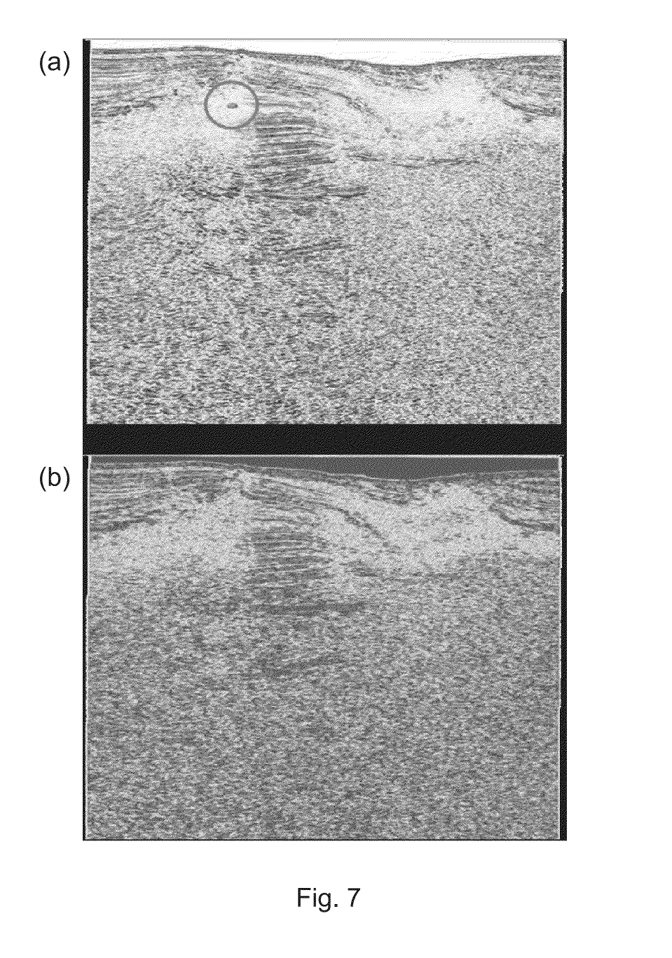

Unfortunately, structure based normal force attributes are not always able to discriminate between the lack of structure associated with salt, and the chaotic nature of migration noise that is caused by wrong migration velocities. In such cases, the lower energy level (lower amplitude) in salt regions versus sediment regions can be exploited. A simple example of an amplitude based salt attribute is the scaled inverse of the amplitude,

$$η = \{ \begin{matrix}1 , & a < {a}_{0} \\ \frac{{a}_{0}}{a} , & a \geq {a}_{0}\end{matrix} \qquad ( 7 )$$

where α is the seismic amplitude, while α₀ is a representative salt amplitude value. The discrimination between salt and high reflectivity sediments depends on the choice of α₀. The value range of the attribute defined by equation (7) is [0, 1]. FIG. 7 illustrates the discrimination obtained by using the attribute η. The reference amplitude value α₀ can be chosen based on the value at some user specified position(s) in the seismic cube.

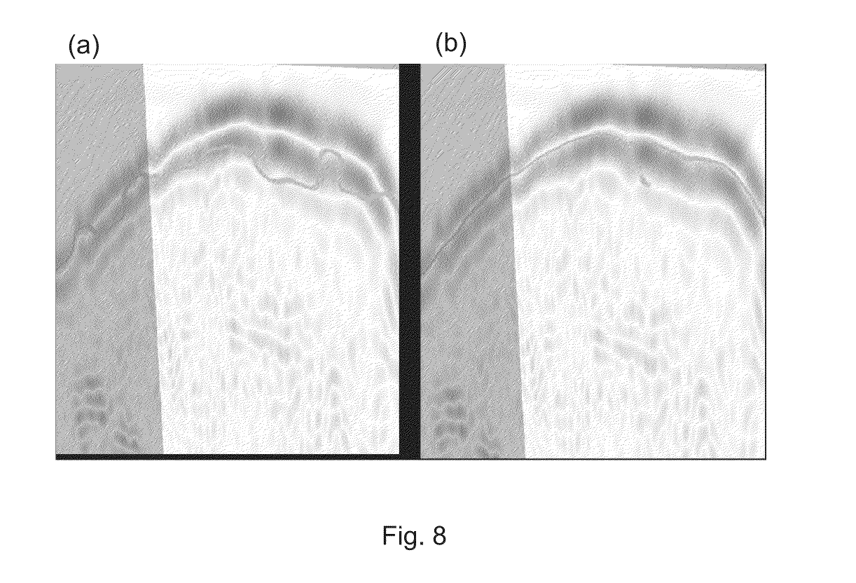

In embodiments of the present invention, the directional force field Fₑ(x) in equation (4) can be used to make the evolution stop at amplitude extrema that represent a salt boundary. By convention, a positive directional force component implies a force contribution in the positive coordinate direction, e.g., towards increasing inline or crossline coordinate values, or towards increasing depth. A negative component implies a force contribution in the opposite direction. An example of a useful directional force field related to amplitude extrema is the gradient of the seismic. For each direction, the gradient will be zero at the extrema, and change sign over the extrema. Consequently, the gradient will locally represent a force field directed towards the closest peak from either side of it. Similarly, by taking the negative of the gradient, a force field locally directed towards the closest trough can be generated. FIG. 8 illustrates the effect of applying a directional force field based on the gradient of the seismic.

In embodiments of the present invention, directional forces are used in conjunction with normal forces. In this way, the boundary of the evolving salt body can be brought close to a salt boundary extrema by normal forces, with the directional forces then dragging the boundary to its final correct position. The directional forces are generally scaled relative to the normal forces such that they eventually dominate over the normal forces, since otherwise the normal forces can drag the boundary away from sediment regions.

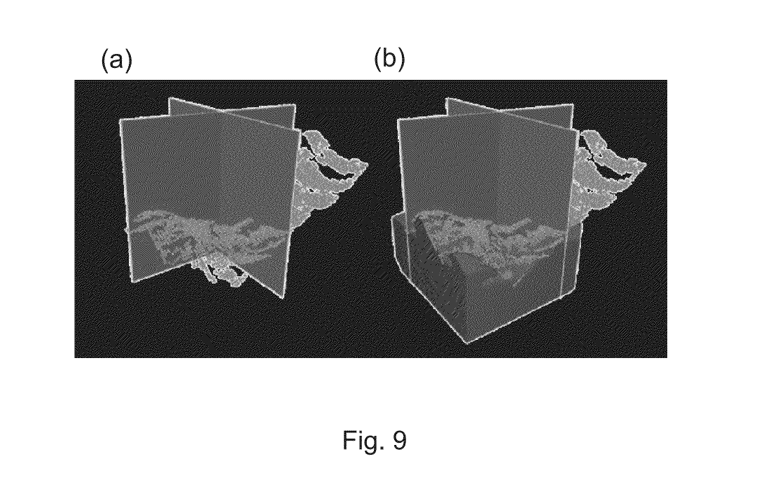

An explicit user constraint may also be applied by means of a local directional force field. For example, an interpreted boundary, such as a horizon interpretation, point set or surface, can be defined as a salt body boundary. The local directional force field can be used to honour that constraint by setting the directional force field to zero at the position of the explicit constraint, and changing sign over it, all other forces being ignored in the neighbourhood of the constraint. FIG. 9 shows an example of how an explicit user constraint is honoured.

The curvature force term in equation (1) is proportional to the mean curvature of the current boundary, which means that it will have an impact on the evolution as long as the boundary has a non-zero mean curvature. Consequently, by suitable choice of F_{c}(x), the smoothness of the resulting body can be controlled. In general, a uniform value of F_{c}(x) in the range 0-0.5 may be applied throughout the seismic volume. An important effect of the curvature force is that it can prevent the evolution from “leaking” through a salt boundary that has an incomplete attribute response. It can also provide a plausible interpolation in regions where the normal and directional forces are weak or inconclusive. In addition, the curvature force can be used in a separate post-processing step, to obtain a smoothed salt boundary.

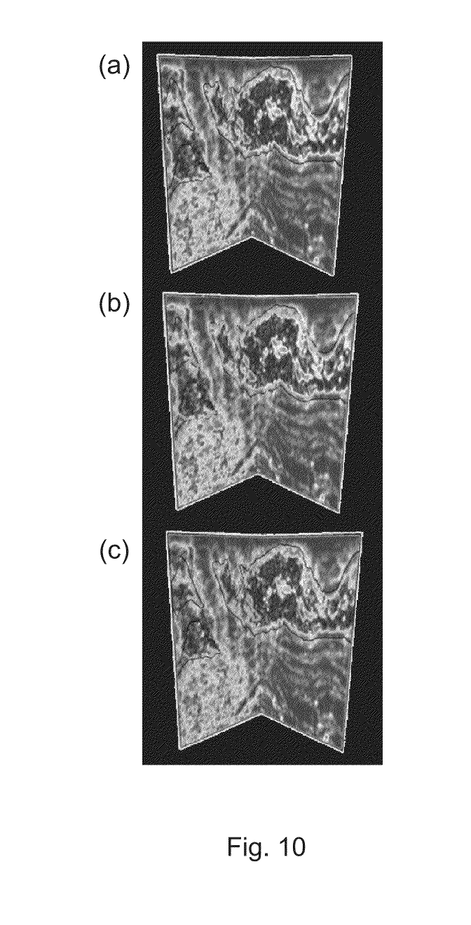

FIG. 10 illustrates the effect of applying a curvature force constraint to avoid leakages and provide a smooth transition in zones where a sharp boundary is not evident from the attribute response. In particular, in FIG. 10(b) where a curvature constraint coefficient of 0.5 is applied, the evolved boundary (green line) smoothly envelopes the positive (blue) normal force attribute, whereas in FIG. 10(c) where no curvature constraint is applied, growth proceeds into narrow, non-smooth features.

By way of example, the present invention has been applied to a data set from the Gulf of Mexico. Several migration cycles were performed to produce a depth-migrated seismic cube and a corresponding velocity cube. By identifying the regions with salt velocities in the velocity cube, a cube with positive values inside salt and negative values outside salt was created. This cube represented the initial body for application of the level set approach. The level set algorithm was run from this initial state, and generated alternative salt models that could be compared with the original model.

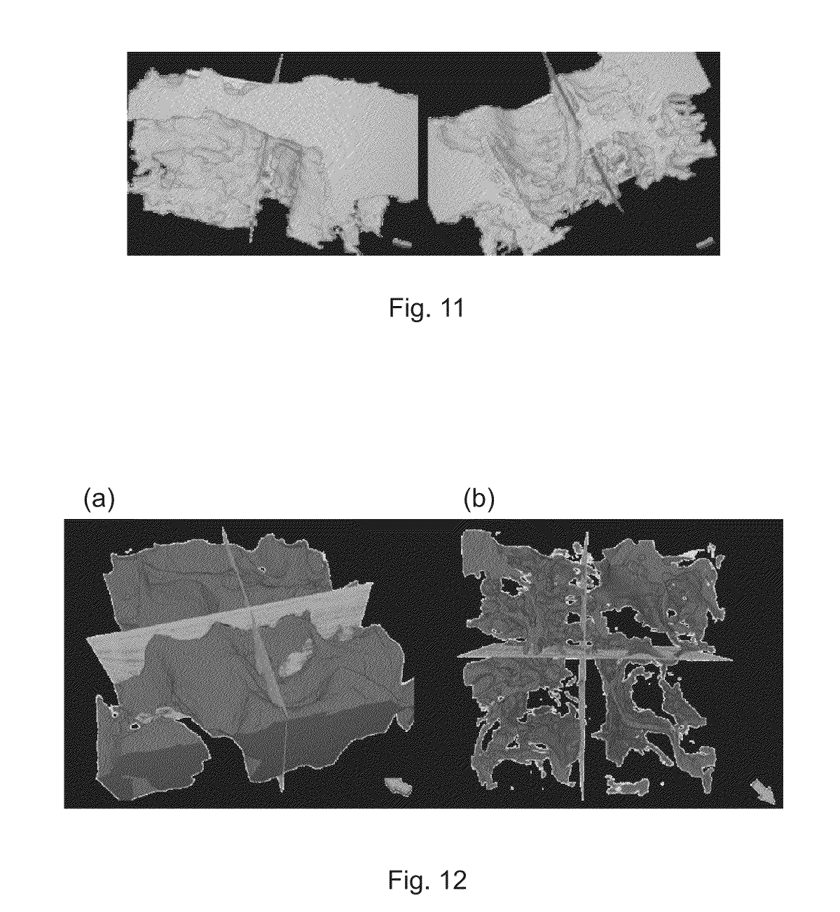

One of the generated alternative salt models was produced by applying normal forces based on the squared Frobenius norm (equation (6)). A directional force field based on the gradient of the seismic was used to improve this result, and FIG. 11 illustrates the complexity of the extracted salt body. FIG. 12 shows (a) regions where the alternative salt model was found to coincide with an original salt model, and (b) regions where the alternative salt model suggested an increased salt extent relative to the original salt model. Some differences between the two models were related to different event picking, including adjustments made by the level set algorithm to hit the correct extrema position. However, other differences could include salt roots, which were not addressed by the original model.

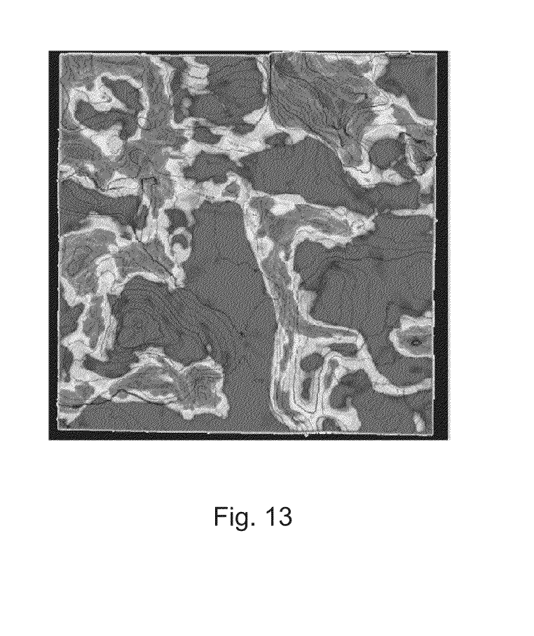

Having a proper salt model can be crucial for subsalt illumination. Missing salt regions in the velocity model can lead to poor illumination in the regions below. FIG. 13 shows a map representing the risk of poor subsalt illumination due to uncertainties in the salt definition above. The map was created by summing the number of additional voxels labelled as salt by the level set result for each column (pseudo trace) in the seismic cube. The regions identified as high risk of poor illumination in the map were found to coincide with some of the most problematic regions in the characterization of subsalt targets in the area. This suggests that another migration step based on the alternative salt model could improve the subsalt illumination.

Automated salt extraction has the potential of greatly reducing the time spent on salt interpretation in an iterative depth migration process. An improved salt extraction methodology also means that that interpretation is improved. Specifically, illumination of subsalt targets can be improved and risk of salt related drilling hazards can be reduced, since depth positioning is improved and the extent of salt is more reliable. As a consequence, the chance of identifying a hydrocarbon formation from the seismic and successfully drilling into it is increased.

All references referred to above are hereby incorporated by reference.

1. A method of extracting a salt body from a geological volume, wherein a starting object is located within the geological volume, the starting object defines an initial salt body boundary, data points are distributed through the geological volume, and the data points are associated with values of one or more geological attributes, comprising:
defining an expression which determines a change in position of the salt body boundary at the data points over an iteration based on the values of the one or more attributes; and
applying the expression at the data points for successive iterations to evolve the salt body boundary over the successive iterations until a final form for the evolved salt body is achieved.

2. A method according to claim 1, wherein the values of a plurality of geological attributes are provided at the data points, and wherein, in the defining step, the values of the attributes are scaled relative to each other.

3. A method according to claim 1, wherein the applying uses the level set approach to apply the expression at the data points for the successive iterations.

4. A method according to claim 1, wherein the geological attributes include seismic attributes selected from the group consisting of: seismic amplitude, seismic higher order derivative, seismic phase, amplitude vs. offset data, chaos, variance, curvature, dip, dip deviation and fracture enhancement attributes.

5. A method according to claim 1, wherein the salt body boundary is fixed at a given data point for subsequent iterations if the boundary has remained stationary at that data point for a predetermined number of successive previous iterations.

6. A method according to claim 1, wherein the salt body boundary is fixed at a given data point for subsequent iterations if the value(s) of one or more of the attributes at that data point match a predefined criterion.

7. A method according to claim 1, further comprising displaying the evolved salt body boundary as a geobody.

8. A method according to claim 7, wherein the evolved salt body boundary is displayed in 2D as a cross section of the geobody.

9. A method according to claim 1, further comprising:
performing seismic testing; and
analysing results of the seismic testing to generate the data points distributed through the geological volume, each data point being associated with the values of one or more respective seismic attributes.

10. A method according to claim 1, further comprising:
using the extracting salt body to determine a drilling trajectory through an earth formation containing the extracted salt body.

11. A method according to claim 1, further comprising:
outputting the extracting salt body to a controller controlling a drilling system for drilling a well in the formation containing the extracted salt body.

12. A method of operating a well, comprising:
performing the method of claim 1; and
using the extracted salt body to manage the operation of the well.
